(19) United States
(12) Patent Application Publication
(10) Pub. No.: US 2008/0137337 A1
(43) Pub. Date: Jun. 12, 2008

(54) Light emitting diode heat dissipating module and display apparatus applied thereto

(75) Inventors: Chin-Ming Cheng, Taoyuan Hsien (TW); Yi-Sheng Lee, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/984,505

(22) Filed: Nov. 19, 2007

(30) Foreign Application Priority Data
Dec. 8, 2006 (TW) 95145985

(51) Int. Cl. F21V 29/00; F21V 21/00

(52) U.S. Cl. 362/249; 362/373

(57) ABSTRACT

A display apparatus, such as a rear projection television, includes a housing, a display panel and a plurality of LED heat dissipating modules disposed in the housing. The display panel is connected to the housing, and each of the LED heat dissipating modules includes a pulsating heat pipe, a plurality of fins, and a plurality of LEDs for providing light to the display panel. The LEDs are disposed on the pulsating heat pipe and located at the vaporizing section, and the fins are connected to the pulsating heat pipe and all located at the condensing section for increasing the heat dissipating area.

This Non-provisional application claims priority under U.S.C. §119(a) on Patent Application No(s). 095145985, filed in Taiwan, Republic of China on Dec. 8, 2006, the entire contents of which are hereby incorporated by reference.

### BACKGROUND OF THE INVENTION

1. Field of the Invention

The invention relates to a heat dissipating module and a display apparatus utilizing the same, and more particularly to a heat dissipating module and a display apparatus utilizing the same applied to a light emitting diode.

2. Description of the Related Art

Because science and technology gradually progresses, electronic products must provide more functions. The variety and functionality of personal computers continually increases. Portable computers, PDAs, cell phones, a handheld computer are the topics of a great deal of research. Products with multiple functions, due to the integration of many electronic elements in one device, increases heat generation, and thus heat-dissipation efficiency directly affects product reliability and lifespan.

Take light emitting diodes (LED) as an example, heat dissipation for the LEDs is visually used several fins or heat pipes, typically connected to the rear of the light emitting diode array to actively or passively dissipate heat generated by the LEDs. FIG. 1 is a schematic view of a conventional light emitting diode(LED) heat dissipating module 10. Several light emitting diodes(LEDs) 11 are arranged on a metal core printed circuit board 12, and several fins 13 are disposed under and connected to the printed circuit board 12 for dissipating heat generated by light emitting diodes 11. If heat dissipation is provided by natural convection only, large numbers of fins are necessary, which causes big volume, heavy weight and high cost for the entire LED heat dissipating module 10. Additionally, different air temperatures result in different air density, and thus the airflow generates to cause natural convection. When air near the heat source absorbs heat to flow upward to the tops of the fins, air absorbs much heat resulting in increased air temperature. Thus, the heat dissipating efficiency near the upper end of the fins is poor. If several LEDs are arranged together, the temperature difference at the highest point and the lowest layers may reach to 7 to 10 degrees. Even though an additional fan is added to provide airflows for forced convection, the airflows can not reach the center of the fins effectively such that the temperature of the light emitting diodes can not be uniform.

The heat pipe is an easy and efficient heat dissipating device, thus, they are extensively applied in a wide variety of heat dissipating electronic products. However, heat pipes employed in large-size rear projection televisions are not able to provide the required heat dissipating efficiency. Compared to fins, heat pipes can improve temperature uniformity of the LEDs, but the the length of the heat pipe is limited to 50 centimeters. In heat pipes over 50 centimeters in length, the working fluid in the heat pipe is unable to quickly return. Thus, heat pipes dry out easily, potentially causing damage. Thus, heat pipes are not employed in light emitting displays over 20 inches.

### BRIEF SUMMARY OF INVENTION

A detailed description is given in the following embodiments with reference to the accompanying drawings. The invention provides a light emitting diode heat dissipating module and a display apparatus utilizing the same. The invention improves the conventional heat pipe by eliminating length limitation of conventional heat pipes, and thus design flexibility is increased. Further, the temperature uniformity can be maintained between all LEDs so as to increase the display efficiency and reliability of the entire display apparatus. Additionally, the light emitting diode heat dissipating module of the present invention is relatively small and light.

The present invention provides a light emitting diode heat dissipating module including a plurality of light emitting diodes(LEDs), a pulsating heat pipe and a plurality of fins. The pulsating heat pipe is divided into a vaporizing section and a condensing section. The LEDs are disposed and completely on the pulsating heat pipe and located at the vaporizing section. The fins are connected to the pulsating heat pipe and are all located at the condensing section of the pulsating heat pipe.

The present invention provides a display apparatus including a housing, a display panel and a plurality of light emitting diode heat dissipating modules. The display panel is connected to the housing. All light emitting diode heat dissipating modules are installed in the housing. The light emitting diode heat dissipating module includes a plurality of LEDs, a pulsating heat pipe and a plurality of fins. The LEDs serve as a light source for the display panel. The pulsating heat pipe is divided into a vaporizing section and a condensing section. The LEDs are disposed and completely on the pulsating heat pipe and located at the vaporizing section. The fins are connected to the pulsating heat pipe and are all located at the condensing section of the pulsating heat pipe.

The present invention further provides a heat dissipating display apparatus utilizing the above-mentioned light emitting diode heat dissipating modules. The light emitting diode heat dissipating modules are installed at the rear of the display panel, and the LEDs are disposed between the heat dissipating modules and the display panel. The pulsating heat pipe is formed with a closed space filled with a working fluid W, like an inorganic compound, pure water, alcohol, ketone, liquid metal, organic compound or a combination thereof. When the working fluid at the vaporizing section absorbs heat generated by the LEDs, a bubble is generated and boiled during evaporation. The bubble pushes the working fluid from the vaporizing section to the condensing section to discharge heat, and then returns to the vaporizing section to complete a cycle.

The LEDs are connected to the pulsating heat pipe by direct mounting, adhering, joining, or welding, or fixed by other equivalent methods. The pulsating heat pipe has a cross section with an outer shape, and the outer shape is semicircular, rectangular, triangular, quadrilateral, trapezoidal, pentagonal, hexagonal, octagonal, other equilateral scalene polygon. Also, in the cross section of the heat pipe can be seen to include an inner shape and the outer shape. The inner shape is circular and the outer shape is rectangular.

The pulsating heat pipe is made by a material with high heat conductivity, such as aluminum; copper, titanium, molybdenum, silver, stainless steel, carbon steel, or other alloys. Also, the display apparatus has a fan installed near the fins for increasing heat convection efficiency. Further, the display apparatus has a circuit board electrically connected to the LEDs, and the circuit board includes a comb structure having a plurality of teeth. Each light emitting diode heat dissipating module can be disposed at a site between each two adjacent teeth of the comb structure.

### BRIEF DESCRIPTION OF DRAWINGS

The invention can be more fully understood by reading the subsequent detailed description and examples with references made to the accompanying drawings, wherein:

FIG. 1 is a schematic view of a conventional light emitting diode heat dissipating module;

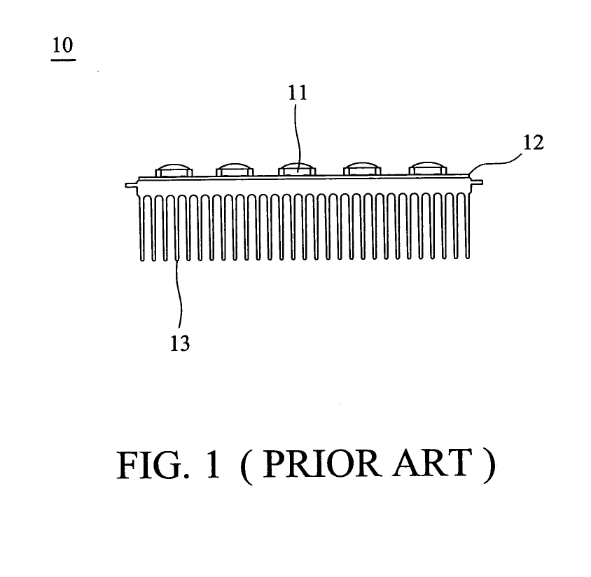

FIG. 2A is a schematic view of an embodiment of a light emitting diode heat dissipating module of the present invention;

FIG. 2B is a cross sectional view of FIG. 2A;

FIG. 2C is a cross sectional view of the vaporizing section of the pulsating heat pipe of FIG. 2A; and

FIG. 3 is an exploded view of an embodiment of a display apparatus of the present invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

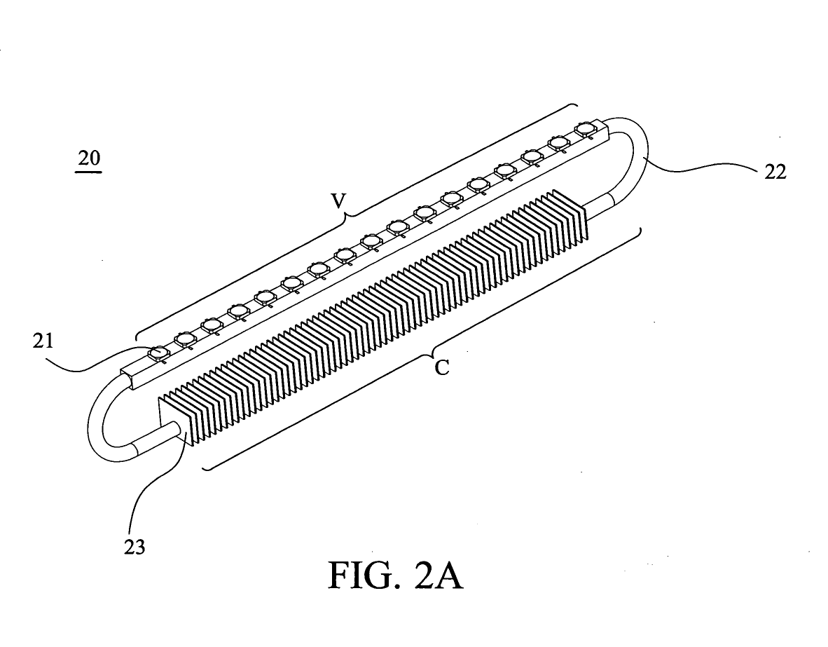

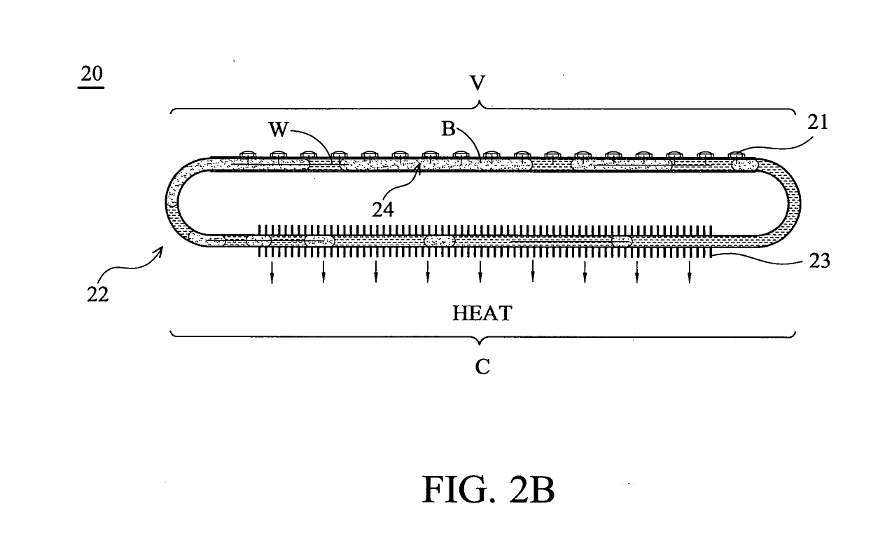

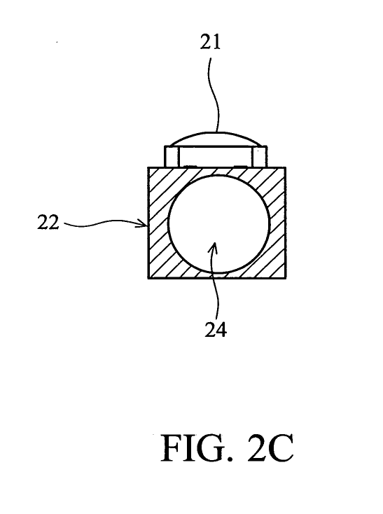

FIG. 2A is a schematic view of an embodiment of a light emitting diode heat dissipating module of the present invention. FIG. 2B is a cross sectional view of FIG. 2A. Please refer both to FIGS. 2A and 2B, the light emitting diode heat dissipating module 20 includes a plurality of light emitting diodes(LEDs) 21, a pulsating heat pipe 22 and a plurality of fins 23. The LEDs 21 are respectively installed on the pulsating heat pipe 22, and the fins 23 are connected to the pulsating heat pipe 22. The pulsating heat pipe 22 is made of a material with high heat conductivity, such as aluminum, copper, titanium, molybdenum, silver, stainless steel, carbon steel, or other alloys.

The operating principle of the pulsating heat pipe 22 is disclosed as follow. Referring to FIG. 2B, the pulsating heat pipe 22 includes a vaporizing section V and a condensing section C. The light emitting diodes 21 are disposed and completely on the pulsating heat pipe 22 and are located at the vaporizing section V of the pulsating heat pipe 22, and the fins 23 are connected to the pulsating heat pipe 22 and are all located at the condensing section C of the pulsating heat pipe 22. The pulsating heat pipe 22 is formed with a closed space 24 which is filled with a working fluid W, like an inorganic compound, pure water, alcohol, ketone, liquid metal, organic compound or a combination thereof.

When the working fluid W at the vaporizing section V of the pulsating heat pipe 22 absorbs heat generated by the LEDs 21, a bubble B is generated and boiled during evaporation. Because the bubble at the vaporizing section V continuously increases, a differential pressure is generated between the vaporizing section V and the condensing section C. As the results, the bubble B pushes the working fluid W from the vaporizing section V to the condensing section C for heat discharge. The working fluid W then returns to the vaporizing section V, and thus the flow cycle of the working fluid W is completed. The flow cycle of the working fluid discharges heat from the LEDs efficiently and continuously.

Compared to a conventional heat pipe, the capillarity and length of the conventional heat pipe are limited. Due to generation and elimination of the bubble B forms a pumping force for driving the working fluid W, the length of the pulsating heat pipe 22 can reach several meters compared to the conventional 50 centimeters, thus increasing design flexibility.

Referring to FIGS. 2A and 2B again, several LEDs21 are disposed and completely on the pulsating heat pipe 22 and located at the vaporizing section V, respectively. The fins 23 are connected to the pulsating heat pipe 22 and are located at the condensing section C of the pulsating heat pipe 22. Thus, heat generated by the LEDs 22 is directly absorbed by the pulsating heat pipe 22 and then quickly conducted to discharge. Also, the working fluid W in the pulsating heat pipe 22 is located in a vapor-liquid phase equilibrium area, and thus the temperature of the pulsating heat pipe 22 is the saturation temperature of the working fluid W, such that the temperature of the vaporizing section V of the pulsating heat pipe 22 keeps consist. Therefore, every LED can keep uniform temperature.

The LEDs 21 are connected to the pulsating heat pipe 22 by direct mounting so as to decrease the contact thermal resistance between the LEDs 21 and the pulsating heat pipe 22, thereby increasing heat conductivity of the light emitting diode heat dissipating module 20. However, the present invention is not limited thereto, for example, the LEDs 21 can be connected to the pulsating heat pipe 22 by adhering, joining, or welding, or fixed by other equivalent methods:

FIG. 2C is a cross sectional view of vaporizing section of the pulsating heat pipe of FIG. 2A. The pulsating heat pipe 22 has a cross section with an outer shape and an outer shape. The inner shape is circular and the outer shape is rectangular. Thus, the LEDs 21 is completely contacted with the vaporizing section V of the pulsating heat pipe 22. Moreover, the fins 23 are located at the condensing section C of the pulsating heat pipe 22 for increasing the heat dissipating area. An additional fan (not shown) is installed near the fins 23 for increasing heat convection efficiency.

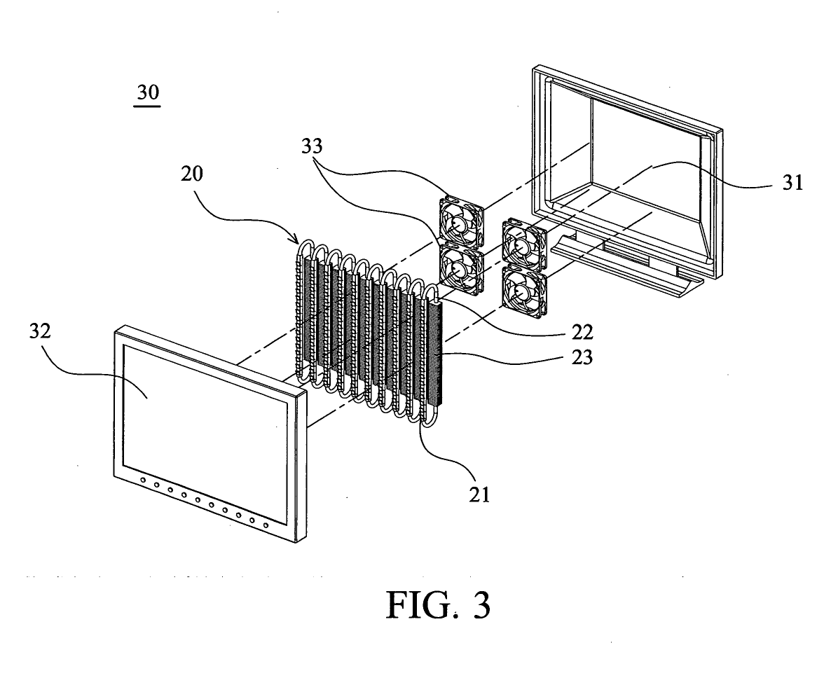

FIG. 3 is an exploded view of an embodiment of a display apparatus of the present invention. A display apparatus 30, for example, a rear projection television with a size larger than 20 inches, includes a housing 31, a display panel 32 and a plurality of light emitting diode heat dissipating modules 20. The display panel 12 is connected to the housing 31. The light emitting diode heat dissipating module 20 includes a plurality of LEDs 21, a pulsating heat pipe 22 and a plurality of fins 23. The LEDs 21 provides lights to the display panel 32, as a light source.

The light emitting diode heat dissipating module 20, the LEDs 21, the pulsating heat pipe 22 and the fins 23 is similar to FIG. 2. The structure is the same as that previously described, thus, further description is omitted for brevity.

As for a large-size rear projection television, more than hundreds of LEDs are necessary to be applied in providing lights. Thus, several light emitting diode heat dissipating modules 20 are disposed at the rear of the display panel 32, and the LEDs 21 face to the display panel 32 for illuminating as a light source for the display panel 32. When heat generated by the LEDs 21, heat can be quickly transmitted to the condensing section C of the pulsating heat pipe 22 via the pulsating heat pipe, and the fins located at the condensing section. C increases heat dissipating area. Also, the fan 33 installed near the fins 23 increases heat convection efficiency by providing airflows.

For simplicity, FIG. 3 does not show a circuit board. In fact, the circuit board is electrically connected to the LEDs 21. The circuit board is preferable a comb structure having a plurality of teeth, and each light emitting diode heat dissipating module 20 in FIG. 2A can be disposed at a site between each two adjacent teeth of the comb structure.

However, the present invention is not limited thereto. For example, FIG. 2C shows the cross sectional view of the pulsating heat pipe 22 of FIG. 2A has a circular inner shape and a rectangular outer shape. Bu the out shape of the cross section of the pulsating heat pipe 22 can be changed to a semicircular, rectangular, triangular, quadrilateral, trapezoidal, pentagonal, hexagonal, octagonal, or other equilateral scalene polygon shape in view of the circular inner shape.

Compared with the conventional heat pipe has limitations of capillarity and length, the pulsating heat pipe 22 of the present invention can reach to several meters, rather than the conventional 50 centimeters. Additionally, because the pulsating heat pipe 22 can be arranged at any angles without limitation, the design flexibility is enhanced. Due to the temperature uniformity of vaporizing section V of the pulsating heat pipe 22, the temperature of each light emitting diode is equalized. Thus, the display efficiency and reliability can be maintained. Compared with the conventional heat pipe, the light emitting diode heat dissipating module 20 decreases the weight and occupied space, so the light emitting diode heat dissipating module 20 of the present invention is relatively small and light.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light emitting diode heat dissipating module, comprising:
a pulsating heat pipe, comprising a vaporizing section and a condensing section opposite thereto;
a plurality of light emitting diodes(LEDs), respectively disposed on the pulsating heat pipe and located at the vaporizing section; and
a plurality of fins, connected to the pulsating heat pipe and all located at the condensing section.

2. The light emitting diode heat dissipating module as claimed in claim 1, wherein the pulsating heat pipe forms a closed space, and the closed space is filled with a working fluid comprising an inorganic compound, pure water, alcohol, ketone, liquid metal, organic compound or a combination thereof.

3. The light emitting diode heat dissipating module as claimed in claim 2, wherein the working fluid at the vaporizing section absorbs heat generated by the LEDs and generates a bubble during evaporation and boiling, the bubble pushes the working fluid from the vaporizing section to the condensing section to discharge heat, and then returns to the vaporizing section to complete a cycle of the working fluid.

4. The light emitting diode heat dissipating module as claimed in claim 1, wherein the LEDs are directly mounted to, adhered to, joined to, or welded to the pulsating heat pipe, or fixed by other equivalent methods.

5. The light emitting diode heat dissipating module as claimed in claim 1, wherein the pulsating heat pipe comprises a cross section with an inner shape, and the inner shape is circular.

6. The light emitting diode heat dissipating module as claimed in claim 1, wherein the pulsating heat pipe comprises a cross section with an outer shape, and the outer shape is a semicircular shape, a rectangular shape, a triangular shape, a quadrilateral shape, a trapezoid, a pentagon, a hexagon, an octagon, other equilateral polygons, or scalene polygons.

7. The light emitting diode heat dissipating module as claimed in claim 1, wherein the pulsating heat pipe comprises a material with high heat conductivity, such as aluminum, copper, titanium, molybdenum, silver, stainless steel, carbon steel, or other alloys.

8. A display apparatus, comprising:
a housing;
a display panel, connected to the housing; and
a plurality of light emitting diode heat dissipating modules, all being disposed in the housing, and each of the light emitting diode heat dissipating modules comprising:
a pulsating heat pipe, comprising a vaporizing section and a condensing section opposite thereto;
a plurality of light emitting diodes(LEDs), respectively disposed on the pulsating heat pipe and located at the vaporizing section; and
a plurality of fins, connected to the pulsating heat pipe and all located at the condensing section;
wherein the LEDs provide lights for the display panel.

9. The display apparatus as claimed in claim 8, wherein the light emitting diode heat dissipating modules are installed at the rear of the display panel, and the LEDs face to the display panel.

10. The display apparatus as claimed in claim 8, wherein the pulsating heat pipe forms a closed space, and the closed space is filled with a working fluid comprising an inorganic compound, pure water, alcohol, ketone, liquid metal, organic compound or a combination thereof.

11. The display apparatus as claimed in claim 10, wherein the working fluid at the vaporizing section absorbs heat generated by the LEDs and generates a bubble during evaporation and boiling, the bubble pushes the working fluid from the vaporizing section to the condensing section to discharge heat, and then goes back the vaporizing section to complete a cycle of the working fluid.

12. The display apparatus as claimed in claim 8, wherein the LEDs are directly mounted to, adhered to, joined to, or welded to the pulsating heat pipe, or fixed by other equivalent methods.

13. The display apparatus as claimed in claim 8, wherein the pulsating heat pipe comprises a cross section with an inner shape, and the inner shape is circular.

14. The display apparatus as claimed in claim 8, wherein the pulsating heat pipe comprises a cross section with an outer shape, and the outer shape is a semicircular shape, a rectangular shape, a triangular shape, a quadrilateral shape, a trapezoid, a pentagon, a hexagon, an octagon, other equilateral polygons, or scalene polygons.

15. The display apparatus as claimed in claim 8, wherein the pulsating heat pipe comprises a cross section with an inner shape and an outer shape, the inner surface is circular and the outer surface is rectangular.

16. The display apparatus as claimed in claim 8, wherein the pulsating heat pipe comprises a material with high heat conductivity, such as aluminum, copper, titanium, molybdenum, silver, stainless steel, carbon steel, or other alloys.

17. The display apparatus as claimed in claim 8, further comprising a fan, wherein the fan is installed near the fins for increasing heat convection efficiency.

18. The display apparatus as claimed in claim 8, further comprising a circuit board electrically connected to the LEDs.

19. The display apparatus as claimed in claim 18, wherein the circuit board comprises a comb structure having a plurality of teeth, the LEDs are respectively disposed at a site between each two adjacent teeth of the comb structure.

20. The display apparatus as claimed in claim 8, wherein the display panel is a rear projection television.
